(19) United States
(12) Patent Application Publication
(10) Pub. No.: US 2018/0170326 A1
(43) Pub. Date: Jun. 21, 2018

(54) Systems And Methods To Control Vehicle Braking Using Steering Wheel Mounted Brake Activation Mechanism

(71) Applicant: GM GLOBAL TECHNOLOGY OPERATIONS LLC, Detroit, MI (US)

(72) Inventors: Peggy Wang, Shanghai (CN); Chengwu Duan, Shanghai (CN); Jimmy Qi, Shanghai (CN); Xiaowen Dai, Shelby Township, MI (US)

(21) Appl. No.: 15/381,249

(22) Filed: Dec. 16, 2016

(51) Int. Cl. B60T 7/08; B60T 8/171

(52) U.S. Cl. CPC B60T 7/085; B60T 2220/00; B60T 8/171

(57) ABSTRACT

Methods and systems for controlling vehicle braking using a steering wheel mounted brake activation mechanism are disclosed herein. In an exemplary embodiment, a method for braking a vehicle includes providing the vehicle with a steering system including a steering wheel having a brake activation mechanism, a braking system, and a controller in electronic communication with the braking system and the brake activation mechanism, receiving a user input from the brake activation mechanism, calculating an amount of vehicle braking to apply based on the user input, and automatically controlling the vehicle braking system based on the calculated amount of vehicle braking.

### INTRODUCTION

The present invention relates generally to the field of vehicle braking and, more specifically, to methods and systems for applying vehicle brakes based on force applied to a steering wheel mounted brake activation mechanism.

Many vehicles are equipped with autonomous and/or semi-autonomous driving systems, applications, and/or features. Autonomous and semi-autonomous driving systems may provide automated driving controls that reduce the driver action required for operating the vehicle.

Safety considerations may be taken into account when designing autonomous and/or semi-autonomous driving systems. In order to conform to safety requirements, the autonomous and/or semi-autonomous driving systems may be overridden by the driver. Specifically, in some situations, a driver may wish to override the automatic braking system of the autonomous and/or semi-autonomous driving system. Accordingly, it is desired to have an improved determination of when a driver wishes to override such systems. Additionally, it is desirable to provide an improved method and system for overriding an automatic vehicle control system, in particular, the vehicle braking system.

### SUMMARY

Embodiments according to the present disclosure provide a number of advantages. For example, embodiments according to the present disclosure enable activation of the vehicle braking system via a steering wheel mounted brake activation mechanism. Pressure on the steering wheel due the operator's grip is measured and analyzed. If an abnormal pressure is detected, the vehicle braking system is activated to slow or stop the vehicle. The steering wheel mounted brake activation mechanism may be used as part of an autonomous or semi-autonomous driving mode or may be used as a supplemental brake activation mechanism when the vehicle is operating in a no automation driving mode under full control of the operator.

In one aspect, a method for braking a vehicle includes providing the vehicle with a steering system including a steering wheel having a steering wheel mounted brake activation mechanism, a braking system, and a controller in electronic communication with the braking system and the brake activation mechanism; receiving, by the controller, a user input from the brake activation mechanism; calculating, by the controller, an amount of vehicle braking to apply based on the user input; and automatically controlling, by the controller, the vehicle braking system based on the calculated amount of vehicle braking.

In some aspects, the method further includes providing the vehicle with an actuator configured to control the vehicle braking system, the actuator in electronic communication with the controller; and in response to the user input, generating, by the controller, a control signal to control the actuator to change a level of braking provided by the vehicle braking system. In some aspects, the method further includes monitoring, by the controller, the user input and generating, by the controller, a user profile based on the user input.

In some aspects, the user input is a steering wheel gripping force.

In some aspects, the method further includes providing the vehicle with a sensing system comprising one or more vehicle sensors, the one or more vehicle sensors configured to generate sensor data corresponding to one or more characteristics of an environment of the vehicle, and automatically controlling, by the controller, the steering system and the braking system based on the sensor data. In some aspects, the method further includes monitoring, by the controller, the sensor data and the user input and correlating, by the controller, the sensor data with the user input to improve an obstacle detection ability of the sensing system.

In another aspect, an automotive vehicle includes a braking system; an actuator configured to control the braking system; a user interface mounted on a vehicle steering wheel; and a controller in electronic communication with the actuator and the user interface, the controller configured to receive a user input from the user interface; calculate an amount of vehicle braking to apply based on the user input; and automatically control the actuator to apply the calculated amount of vehicle braking.

In some aspects, the user interface comprises one or more pressure sensors mounted on the vehicle steering wheel. In some aspects, the user input is one or more of steering wheel gripping force data, grip intensity data, and grip frequency data. In some aspects, the controller is further configured to monitor the user input and generate a user profile based on the user input. In some aspects, the user profile includes one or more of steering wheel gripping force data, grip intensity data, and grip frequency data gathered during operation of the automotive vehicle.

In some aspects, the automotive vehicle further includes a steering system, a throttle system, and a sensing system including one or more vehicle sensors, the vehicle sensors configured to generate sensor data corresponding to one or more characteristics of an environment of the vehicle, and wherein the controller is further configured to control the steering system, the braking system, and the throttle system based on the sensor data.

In some aspects, the controller is further configured to monitor the sensor data and the user input and correlate the sensor data with the user input to improve an obstacle detection ability of the sensing system.

In yet another aspect, a system for automatically controlling vehicle braking, includes a user interface mounted on a vehicle steering wheel; an actuator configured to control a vehicle braking system; and a controller in electronic communication with the user interface and the actuator, the controller configured to receive a user input from the user interface, calculate an amount of vehicle braking to apply based on the user input, and automatically control the actuator to apply the calculated amount of vehicle braking.

In some aspects, the user interface includes one or more sensors configured to measure one or more user grip characteristics including one or more of a grip strength, a grip frequency, and a grip duration of a grip of a user on the vehicle steering wheel. In some aspects, the one or more sensors include one or more pressure sensors. In some aspects, the one or more pressure sensors include one or more piezoresistive force sensors.

In some aspects, the controller is further configured to analyze the one or more user grip characteristics and generate a user profile based on the analyzed grip characteristics.

In some aspects, the system further includes a steering system, a throttle system, and a sensing system including one or more vehicle sensors, the vehicle sensors configured to generate sensor data corresponding to one or more characteristics of an environment of the vehicle, and wherein the controller is further configured to control the steering system, the braking system, and the throttle system based on the sensor data. In some aspects, the controller is further configured to monitor the sensor data and the user input and correlate the sensor data with the user input to improve an obstacle detection ability of the sensing system.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment.

FIG. 2 is a schematic diagram of a steering wheel with a brake activation mechanism, according to an embodiment.

FIG. 3 is a schematic diagram of a steering wheel with a brake activation mechanism, according to another embodiment.

FIG. 4 is a schematic block diagram of an automated driving assistance system (ADAS) for a vehicle, according to an embodiment.

FIG. 5 is a flow chart of a method to activate a vehicle braking system due to pressure on a steering wheel mounted brake activation mechanism, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Many vehicles are equipped with autonomous and/or semi-autonomous driving systems, applications, and/or features, such as automated steering, braking, throttle, and shifting systems. Autonomous and semi-autonomous driving systems may provide automated driving controls that reduce the driver action required for operating the vehicle. A controller receives information regarding vehicle characteristics and environmental conditions from a vehicle sensing system including a variety of sensors and generates one or more control signals based on the information, including, in some embodiments, a braking control signal. However, in some scenarios, the sensing system may fail to detect or take action in certain conditions requiring vehicle braking. In some scenarios, the driver may detect an upcoming obstacle or hazard before the sensing system detects the obstacle or hazard. Additionally, in some vehicles equipped with a cruise feature, the driver may have placed his or her foot away from the brake pedal and therefore may not respond quickly enough to an upcoming obstacle or hazard, typically resulting in a panic stop.

The methods and systems discussed herein enable a vehicle to learn a steering wheel gripping force. Based on the force measured by a steering wheel-mounted brake activation mechanism, such as a pressure sensor, a controller of the vehicle can determine whether the force is similar to the gripping force measured and tracked during normal autonomous, semi-autonomous, or full operator control operation of the vehicle or if the gripping force indicates a stronger “panic” gripping force that may result if a driver detects an upcoming obstacle or hazard. If the controller determines that the detected gripping force is stronger than an expected or learned threshold, the controller generates a control signal to activate vehicle braking. Throughout the following disclosure, the term “normal” is used to indicate operation of the vehicle when no hazards or obstacles are detected.

Additionally, for vehicles having an automated driving assistance system or ADAS, the methods and systems discussed herein enable improvement of the vehicle sensing system's ability to detect obstacles or hazards along the path of travel. The information provided by the steering wheel-mounted brake activation system can be used to improve the recognition accuracy of the vehicle sensing system including hazard detection. For example, a gripping force that is “abnormal” or outside of the expected range as determined by periodic monitoring of the operator's gripping force can be stored by the controller as a hazard detection event and compared with data from the vehicle sensing system, such as RADAR or LIDAR images, optical images, or other sensor information to confirm a detected obstacle and/or to improve the detection accuracy of the sensing system.

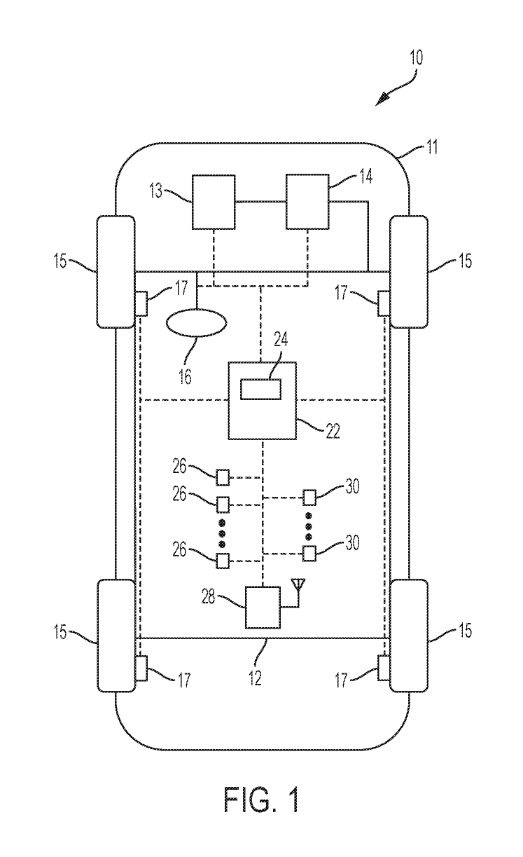

FIG. 1 schematically illustrates an automotive vehicle 10 according to the present disclosure. The vehicle 10 generally includes a body 11, a chassis 12, and wheels 15. The body 11 is arranged on the chassis 12 and substantially encloses the other components of the vehicle 10. The body 11 and chassis 12 may jointly form a frame. The wheels 15 are each rotationally coupled to the chassis 12 near a respective corner of the body 11. The vehicle 10 is depicted in the illustrated embodiment as a passenger car, but it should be appreciated that any other vehicle including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 10 additionally includes a steering system 16 including a steering wheel mounted brake activation mechanism, discussed below. In various embodiments, the vehicle 10 also includes a wireless communication system 28. In some embodiments, the wireless communication system 28 includes a navigation system configured to provide location information in the form of GPS coordinates (longitude, latitude, and altitude/elevation) to a controller 22. In some embodiments, the wireless communication system 28 may include a Global Navigation Satellite System (GNSS) configured to communicate with global navigation satellites to provide autonomous geo-spatial positioning of the vehicle 10. In the illustrated embodiment, the wireless communication system 28 includes an antenna electrically connected to a receiver.

With further reference to FIG. 1, the vehicle 10 also includes a sensing system including a plurality of sensors 26 configured to measure and capture data on one or more vehicle characteristics, including but not limited to vehicle speed, vehicle heading, and a user input such as a steering wheel gripping force. In the illustrated embodiment, the sensors 26 include, but are not limited to, an accelerometer, a speed sensor, a heading sensor, one or more pressure sensors mounted on the steering wheel 16, or other sensors that sense observable conditions of the vehicle or the environment surrounding the vehicle and may include RADAR, LIDAR, optical cameras, thermal cameras, ultrasonic sensors, and/or additional sensors as appropriate. The vehicle 10 also includes a plurality of actuators 30 configured to receive control commands to control steering, shifting, throttle, braking, or other aspects of the vehicle 10, as discussed in greater detail below.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

In some embodiments, the controller 22 includes an automated driving assistance system (ADAS) 24 for automatically controlling various actuators in the vehicle. In an exemplary embodiment, the ADAS 24 is a so-called Level Three, Level Four, or Level Five automation system. A Level Three system indicates limited self-driving automation, referring to the driving mode-specific performance by an automated driving system of all driving functions under certain traffic or environmental conditions while the driver is expected to be available for occasional control. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADAS 24 is configured to control the propulsion system 13, transmission 14, steering system 16, and wheel brakes 17 to control vehicle acceleration, steering, and braking, respectively, with or without human intervention via the plurality of actuators 30 in response to inputs from the plurality of sensors 26, which may include GPS, RADAR, LIDAR, optical cameras, thermal cameras, ultrasonic sensors, pressure sensors, and/or additional sensors as appropriate.

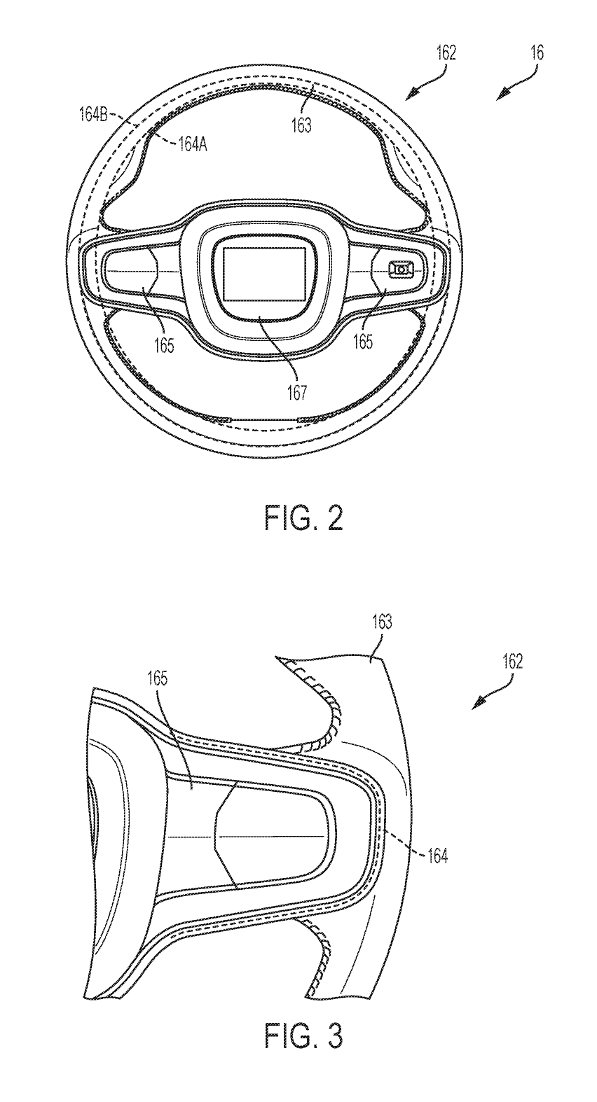

FIG. 2 illustrates one embodiment of a steering system 16 having a steering wheel 162 equipped with a brake activation mechanism. In some embodiments, the brake activation mechanism is a user interface that includes one or more pressure sensors 164A, 164B electrically connected to the controller 22. The steering wheel 162 includes an outer ring 163 and one or more spokes 165 connecting the outer ring 163 to a steering wheel hub 167. The one or more pressure sensors 164A, 164B are one type of sensor 26 that provides information to the controller 22 as discussed above. In some embodiments, the one or more pressure sensors 164A, 164B are piezoelectric sensors or piezoresistive force sensors. In some embodiments, the pressure sensors 164A, 164B form more than one ring along the outer ring 163 of the steering wheel 162, including but not limited to 2 or 4 rings. The pressure sensors 164A, 164B capture user input data on the operator's grip strength on the outer ring 163 at periodic intervals during operation of the vehicle. Capturing grip strength data at different times and transmitting this data to the controller 22 provides the controller 22 with data to determine a “normal” operation gripping force to compare with a “panic situation” gripping force indicating an abnormal user takeover situation and desired braking command. The controller 22 processes and analyzes the data from the pressure sensors 164A, 164B to generate a learned user profile of the operator's grip strength on the outer ring 163 in order to improve hazard detection accuracy and calculate an amount of vehicle braking to apply or a level of vehicle braking provided by the vehicle braking system based on the grip strength.

FIG. 3 illustrates an enlarged view of one spoke of an embodiment of a steering wheel 162. In this embodiment, the spoke 165 includes a brake activation mechanism. The brake activation mechanism includes a pressure sensor 164 along at least part of an outer perimeter of the spoke 165. FIG. 3 illustrates one spoke 165; however, in other embodiments, the steering wheel 162 shown in FIG. 3 could include two or more spokes 165, and each spoke 165 may include a pressure sensor 164.

Similar to the pressure sensors 164A, 164B placed on the outer ring 163 in FIG. 2, the pressure sensor 164 placed on one or more of the spokes 165 captures data on the operator's grip strength or pressure strength on the spoke 165 at different times during operation of the vehicle. For example, an operator's hands may be placed lightly on the spokes 165 of the steering wheel 162 while the vehicle is operating in a cruise or steady state mode (such as Level Three, Level Four, or Level Five automation), as this hand position may be more comfortable for the operator. The sensor 164 measures a grip strength during this period of operation and also measures grip strength if the operator detects an obstacle or hazard and more forcefully grips the steering wheel 162 on the spokes 165. The controller 22 processes and analyzes the data from the pressure sensors 164 to generate a learned user profile of the operator's grip strength on the spokes 165 in order to detect abnormal traffic events as indicated by a detected abnormal grip strength or pressure and calculate an amount of vehicle braking to apply or a level of vehicle braking provided by the vehicle braking system based on the grip strength.

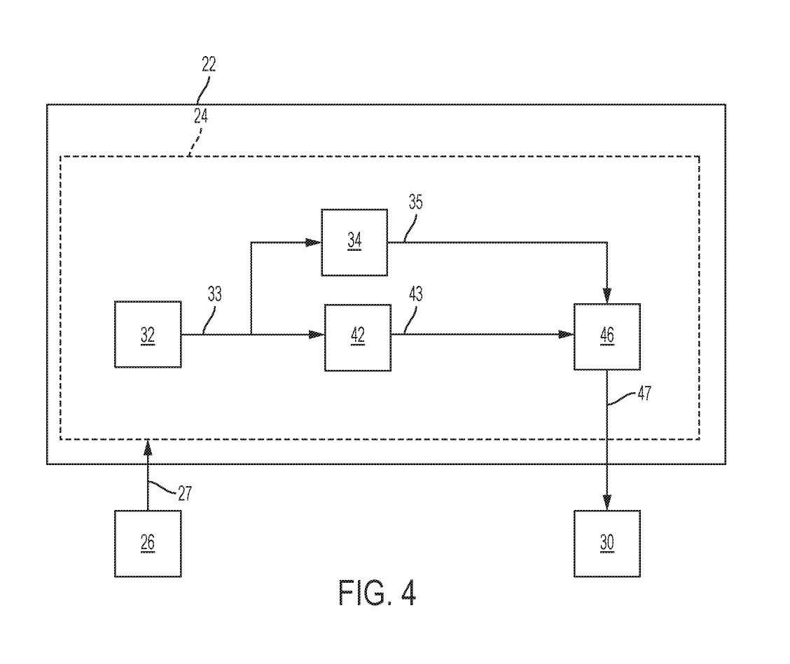

As shown in FIG. 4, one embodiment of the ADAS 24 includes multiple distinct control systems to autonomously and semi-autonomously control the acceleration, braking, and throttle systems of the vehicle 10. In some embodiments, the ADAS 24 includes a sensor fusion and preprocessing module 32 that processes and synthesizes sensor data 27 from the variety of sensors 26, including the pressure sensors 164. The sensor fusion and preprocessing module 32 performs calibration of the sensor data 27, including, but not limited to, pressure sensor data preprocessing and calibration. The sensor fusion and preprocessing module 32 outputs preprocessed sensor output 33. The sensor output 33 includes various calculated parameters including, but not limited to, whether the operator's hand or hands are on the steering wheel, a gripping force on a steering wheel outer rim or spoke, information regarding detected objects, a location of a detected obstacle relative to the vehicle, a predicted path of the detected obstacle relative to the vehicle, and a location and orientation of traffic lanes relative to the vehicle.

With continued reference to FIG. 4, the ADAS 24 also includes a learning and calculation module 34 for analyzing the pressure sensor data and determining whether the data indicates a detected hazard based on reinforcement learning. The learning and calculation module 34 generates learning output 35. Using reinforcement learning, the learning and calculation module 34 tracks and learns features of the operator's grip on the steering wheel outer rim or spokes by analyzing the user input including one or more of gripping force, intensity, and frequency as the operator holds the wheel to detect an abnormal takeover scenario. An abnormal takeover scenario is one in which the operator detects an obstacle that is not detected by the ADAS 24 and/or the operator takes action to avoid a detected obstacle earlier than the vehicle initiates action. An abnormal takeover is indicated when the operator grips the steering wheel and generates an “abnormal” or increased pressure signal, indicating that vehicle braking should be applied. In some embodiments, the learning and calculation module 34 receives the sensor output 33, including data on the gripping force of the operator on the steering wheel outer rim or spoke and analyzes the data against a predetermined threshold. In some embodiments, the predetermined threshold is a predetermined gripping force. In some embodiments, the threshold gripping force is learned from periodic data processed and analyzed by the learning and calculation module 34. If the gripping force measured by the one or more pressure sensors 164 is greater than or significantly different than the predetermined gripping force or the learned threshold gripping force, the ADAS 24 determines that a hazard has been detected and generates a control signal that is transmitted to the vehicle braking system. The pressure data obtained when the operator holds or grips the steering wheel when taking over control of the vehicle during an autonomous mode of operation is tracked and analyzed by the learning and calculation module 34. Additionally, when the vehicle is operating under no automation, the learning and calculation module 34 tracks and analyzes the pressure data to learn the characteristics of the operator's grip on the steering wheel during a no automation mode of operation.

In some embodiments, the learning and calculation module 34 receives the sensor output 33, including gripping force data from the one or more pressure sensors 164 in periodic time intervals. The periodic time intervals may be predetermined and in some embodiments the sampling interval is between approximately 10 Hz and 50 Hz. The learning and calculation module 34 receives the periodic gripping force data and analyzes the data to learn the difference between a “normal” gripping force and an “abnormal” or “panic” gripping force. A “normal” gripping force is pressure force data detected and tracked while the vehicle is operating without any hazards detected by the vehicle sensing system, including the sensors 26, or when the vehicle is operating under full operator control and the operator has not detected any hazards or obstacles. An “abnormal” gripping force is pressure force data indicating that the operator has detected a hazard or obstacle that may or may not have been detected by the vehicle sensors 26. Data indicating a higher gripping force than the normal gripping force may indicate an “abnormal” gripping force. The difference between the “normal” gripping force and the “abnormal” gripping force may be measured as a difference greater than a predetermined amount, such as, for example and without limitation, about 8 psi. In some embodiments, the “abnormal” gripping force is a gripping force that is substantially higher than the “normal” gripping force, and may be approximately 8 psi or approximately 10 psi greater than measured “normal” gripping force. In some embodiments, an “abnormal” gripping force is determined by comparing the data against data gathered during vehicle operation under no automation, semi-automation, or full-automation operation. Because operator grip pressure or strength on the steering wheel may vary depending on whether the vehicle is operating solely under the operator's control (no automation) or under semi- or full-automation, in some embodiments, the mode of operation during which the pressure data is obtained is also tracked and analyzed by the learning and calculation module 34 of the controller 22 to provide a more complete profile of the operator's “normal” gripping force or strength in various vehicle operation modes.

The learning and calculation module 34 analyzes and records the gripping force data to learn when an abnormal takeover scenario occurs to improve hazard detection accuracy and decrease the number of false positive results (that is, the false detection of hazards or obstacles). The learning and calculation module 34 tracks and learns features of the operator's grip on the steering wheel outer rim or spokes by analyzing, for example and without limitation, gripping force, intensity, and frequency as the operator holds the wheel during various modes of vehicle operation. An abnormal takeover occurs when the controller 22 detects, via the one or more pressure sensors 164, that the operator is holding the steering wheel in a way that differs from sensor data gathered when the operator is holding the steering wheel during normal operation of the vehicle 10. The characteristics of the operator's handling of the steering wheel during autonomous versus non-autonomous operation of the vehicle 10 can vary and, as discussed further below, the learning and calculation module 34 processes and analyzes the sensor data to identify these distinctions.

Using reinforcement learning, the learning and calculation module 34 analyzes data from the one or more pressure sensors 164 to learn an individual operator's grip patterns during autonomous driving modes of operation and during non-autonomous driving modes of operation. During autonomous driving modes of operation, aspects of the vehicle 10 such as steering, braking, throttle, etc. are automatically controlled by the various modules of the ADAS 24. In some embodiments, autonomous driving modes include feature such as blind spot monitoring, active cruise monitoring with brake assist, among other features. Non-autonomous driving modes of operation include traditional, operator-controlled driving in which the operator controls the steering and braking directly without autonomous control provided by the ADAS 24. In each driving mode of operation, the operator may interact with the steering wheel differently. For example, during an autonomous driving mode, the operator may only lightly grip or hold the steering wheel, or may completely remove his or her hands from the steering wheel for a period of time. During a non-autonomous driving mode, the operator may grip the steering wheel more firmly than when the vehicle is operating in an autonomous or semi-autonomous mode.

By analyzing the digital signals received from the pressure sensors 164, the learning and calculation module 34 can learn to recognize patterns of operator grip and handling during non-autonomous driving modes and autonomous or semi-autonomous driving modes. In addition to digital signal patterns, the data from the pressure sensors 164 also provides information on the operator's individual grip properties or habits, such as, for example and without limitation, pressure power, duration of grip, response time when an obstacle is detected by the ADAS 24, etc. The learning and calculation module 34 uses this additional information to generate a personal profile or model of the operator that is used to classify an abnormal action such as a grip strength of greater power or increase duration indicating an abnormal takeover event.

Additionally, the learning and calculation module 34 continually logs and reviews the data received from the pressure sensors 164 as well as monitors the data received from the other sensors 26 that indicate the status of the vehicle and the external environment of the vehicle including any detected obstacles, etc. The sensor data associated with false positives, that is, application of the brakes in scenarios in which brake activation was not intended by the operator, are logged and used to improve the learning model by comparing the data to actual brake activation events indicated by an abnormal action such as a stronger gripping force or a grip position outside of a normal, defined grip area. As discussed above, the learning and calculation module 34 tracks and monitors the data associated with abnormal grip pressure. Because abnormal grip pressure can indicate that the operator has detected a hazard or obstacle, the controller 22 can correlate the pressure sensor data with data from the other sensors 26 to improve hazard or obstacle detection. In some scenarios, the operator may detect a hazard or obstacle before the hazard or obstacle is detected by the sensors 26. Comparing the pressure sensor data to the data obtained from the other sensors 26 can improve the response of the ADAS 24 to the detected hazard or obstacle.

As shown in FIG. 4, the ADAS 24 also includes a path planning module 42 for determining a vehicle path to be followed to maintain the vehicle on the desired route while obeying traffic laws and avoiding any detected obstacles. The path planning module 42 employs a first obstacle avoidance algorithm configured to track and avoid any detected obstacles in the vicinity of the vehicle, a first lane keeping algorithm configured to maintain the vehicle in a current traffic lane, and a first route keeping algorithm configured to maintain the vehicle on the desired route. The path planning module 42 is configured to receive the sensor output 33. The path planning module 42 processes and synthesizes the sensor output 33 and generates a path planning output 43. The path planning output 43 includes a commanded vehicle path based on the vehicle route, vehicle location relative to the route, location and orientation of traffic lanes, and the presence and path of any detected obstacles.

The ADAS 24 further includes a vehicle control module 46 for issuing control commands to vehicle actuators 30. The vehicle control module 46 employs a first path algorithm for calculating a vehicle path. The vehicle control module 46 is configured to receive the path planning output 43 and the learning output 35. The vehicle control module 46 processes the path planning output 43 and the learning output 35 and generates a vehicle control output 47. The vehicle control output 47 includes a set of actuator commands to achieve the commanded path from the vehicle control module 46, including but not limited to a steering command, a shift command, a throttle command, and a brake command.

The vehicle control output 47 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

The vehicle 10 is discussed above as including the various modules of the ADAS 24. In some embodiments, the vehicle 10 may not include an ADAS 24. In some embodiments, the ADAS 24 of the vehicle 10 may include more or fewer modules than those discussed above.

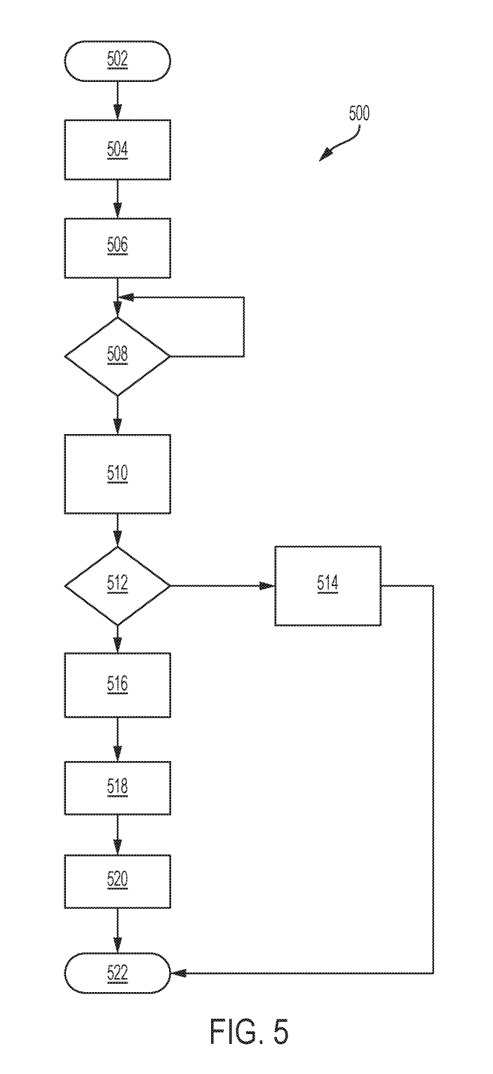

As discussed above, data obtained from the pressure sensors 164, including, for example and without limitation, grip intensity, location, and frequency, are measured and tracked to determine an abnormal gripping event, indicating an abnormal takeover or override scenario in which the vehicle brakes are applied to avoid a detected obstacle. FIG. 5 is a flow chart of a method 500 illustrating the reinforcement learning and determination of an abnormal takeover or override scenario using the grip force measured by one or more pressure sensors on the vehicle steering wheel. The method 500 can be utilized in connection with the vehicle 10, the controller 22, the various modules of the ADAS 24, and the actuators 30, in accordance with exemplary embodiments. The order of operation within the method 500 is not limited to the sequential execution as illustrated in FIG. 5, but may be performed in one or more varying orders as applicable and in accordance with the present disclosure.

As shown in FIG. 5, starting at 502, the method 500 proceeds to step 504. At 504, the ADAS 24 of the controller 22 is engaged to control various aspects of the vehicle 10 such as steering, braking, and throttle. In some embodiments, the vehicle 10 is operated in a fully autonomous or semi-autonomous mode, as discussed above. However, in some embodiments, the vehicle 10 is operated in non-autonomous mode and in this operating scenario the method progresses directly to 506. Next, at 506, the brake activation mechanism on the steering wheel is enabled, that is, any abnormal pressure sensor data from the steering wheel mounted brake activation mechanism or data indicating an abnormal takeover event results in application of the wheel brakes 17.

At 508, the controller 22 determines if the operator is holding or gripping the steering wheel 162. As discussed above, this determination is made by processing the sensor data obtained by the one or more pressure sensors 164 of the brake activation mechanism on the steering wheel 162. If the sensor data does not indicate that the operator is holding or gripping the steering wheel, the controller 22 continues to monitor the sensor data until the data indicates that the operator is holding the steering wheel.

Once the controller 22 determines that the operator is holding the steering wheel, the method 500 proceeds to 510. At 510, the learning and calculation module 34 initiates logging and analyzing the sensor data from the sensors 164 to learn characteristics of the operator's handling of the steering wheel during autonomous mode operation, including characteristics such as, for example and without limitation, the operator's hand strength, grip position, intensity, and duration of grip. Sensor data logging and analysis continues throughout the duration of the method 500.

Next, at 512, the controller 22 determines if there has been an abnormal takeover event. As discussed above, an abnormal takeover event is signaled when the learning and calculation module 34 determines that the data received from the one or more pressure sensors 164 deviates from the sensor data expected during autonomous or semi-autonomous vehicle operation. As discussed above, the pressure sensor data could indicate a deviation from the learned or predetermined grip force for autonomous, semi-autonomous, or non-autonomous vehicle operation, depending on the vehicle operating mode. For example and without limitation, the deviation could indicate a higher than expected grip force, a grip of a longer duration, etc. If the controller determines that, while the operator is gripping or holding the steering wheel, there has not been an abnormal takeover event, the method 500 proceeds to 514 and one or more autonomous driving features are disengaged based on the working scheme of the automation feature, such as, for example and without limitation, a cruise feature, if the vehicle is operating in an autonomous or semi-autonomous mode. The method 500 then proceeds to 522 and ends.

However, if the controller 22 determines that the sensor data indicates an abnormal takeover event, the method proceeds to 516 and the controller 22 enables brake-by-wire of the vehicle 10 using the brake activation mechanism mounted on the vehicle steering wheel. As discussed above, the brake activation mechanism includes one or more pressure sensors 164. Next, at 518, the control module 46 generates a control signal 47 to control the vehicle braking system including the wheel brakes 17. The control signal 47 is generated based on the learned profile of the operator's grip characteristics and a predetermined braking scheme. For example, the control signal 47 generated by the control module 46 may be based on the pressure of the operator's grip as compared to the grip pressure measured when the vehicle 10 is operated during normal or autonomous driving modes. If, for example, the operator's grip on the steering wheel is measured by the pressure sensors 164 as sudden and intense, the wheel brakes 17 may be applied more strongly than when an abnormal grip is measured but the grip strength falls between a sudden and intense measurement and a normal measurement. Various braking level thresholds may be defined based on general grip characteristics and may be redefined as the learning and calculation module 34 develops a profile of the individual operator's grip strength during the reinforcement learning process. The braking levels will also vary according to weather conditions. For example, in inclement weather conditions such as rain or snow, the braking will be applied more smoothly and with more gradual deceleration.

The method 500 then proceeds to 520 and the scenario, including the applied braking force and the measured operator grip force, are logged by the controller 22 as an additional data point to improve the reinforcement learning of the learning and calculation module 34. The method 500 then proceeds to step 522 and ends.

The method 500 is discussed above in the context of autonomous or semi-autonomous driving modes of operation. However, use of the steering wheel mounted brake activation mechanism is not limited to vehicles operating in autonomous or semi-autonomous modes. In other embodiments, aspects of the method 500, including the steering wheel mounted brake activation mechanism, could be used during non-autonomous vehicle operation as a supplemental brake activation mechanism (that is, a brake-by-wire activation mechanism) during sudden or “panic” stop situations.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for braking a vehicle, the method comprising:
providing the vehicle with a steering system comprising a steering wheel having a steering wheel mounted brake activation mechanism, a braking system, and a controller in electronic communication with the braking system and the brake activation mechanism;
receiving, by the controller, a user input from the brake activation mechanism;
calculating, by the controller, an amount of vehicle braking to apply based on the user input; and
automatically controlling, by the controller, the vehicle braking system based on the calculated amount of vehicle braking.

2. The method of claim 1 further comprising:
providing the vehicle with an actuator configured to control the vehicle braking system, the actuator in electronic communication with the controller; and
in response to the user input, generating, by the controller, a control signal to control the actuator to change a level of braking provided by the vehicle braking system.

3. The method of claim 1 further comprising monitoring, by the controller, the user input and generating, by the controller, a user profile based on the user input.

4. The method of claim 3, wherein the user input is a steering wheel gripping force.

5. The method of claim 3 further comprising providing the vehicle with a sensing system comprising one or more vehicle sensors, the one or more vehicle sensors configured to generate sensor data corresponding to one or more characteristics of an environment of the vehicle, and automatically controlling, by the controller, the steering system and the braking system based on the sensor data.

6. The method of claim 5 further comprising monitoring, by the controller, the sensor data and the user input and correlating, by the controller, the sensor data with the user input to improve an obstacle detection ability of the sensing system.

7. An automotive vehicle, comprising:
a braking system;
an actuator configured to control the braking system;
a user interface mounted on a vehicle steering wheel; and
a controller in electronic communication with the actuator and the user interface, the controller configured to
receive a user input from the user interface;
calculate an amount of vehicle braking to apply based on the user input; and
automatically control the actuator to apply the calculated amount of vehicle braking.

8. The automotive vehicle of claim 7, wherein the user interface comprises one or more pressure sensors mounted on the vehicle steering wheel.

9. The automotive vehicle of claim 8, wherein the user input is one or more of steering wheel gripping force data, grip intensity data, and grip frequency data.

10. The automotive vehicle of claim 9, wherein the controller is further configured to monitor the user input and generate a user profile based on the user input.

11. The automotive vehicle of claim 10, wherein the user profile includes one or more of steering wheel gripping force data, grip intensity data, and grip frequency data gathered during operation of the automotive vehicle.

12. The automotive vehicle of claim 11 further comprising a steering system, a throttle system, and a sensing system comprising one or more vehicle sensors, the vehicle sensors configured to generate sensor data corresponding to one or more characteristics of an environment of the vehicle, and wherein the controller is further configured to control the steering system, the braking system, and the throttle system based on the sensor data.

13. The automotive vehicle of claim 12, wherein the controller is further configured to monitor the sensor data and the user input and correlate the sensor data with the user input to improve an obstacle detection ability of the sensing system.

14. A system for automatically controlling vehicle braking, comprising:
a user interface mounted on a vehicle steering wheel;
an actuator configured to control a vehicle braking system; and
a controller in electronic communication with the user interface and the actuator, the controller configured to receive a user input from the user interface, calculate an amount of vehicle braking to apply based on the user input, and automatically control the actuator to apply the calculated amount of vehicle braking.

15. The system of claim 14, wherein the user interface includes one or more sensors configured to measure one or more user grip characteristics including one or more of a grip strength, a grip frequency, and a grip duration of a grip of a user on the vehicle steering wheel.

16. The system of claim 15, wherein the one or more sensors include one or more pressure sensors.

17. The system of claim 16, wherein the one or more pressure sensors include one or more piezoresistive force sensors.

18. The system of claim 16, wherein the controller is further configured to analyze the one or more user grip characteristics and generate a user profile based on the analyzed grip characteristics.

19. The system of claim 14 further comprising a steering system, a throttle system, and a sensing system comprising one or more vehicle sensors, the vehicle sensors configured to generate sensor data corresponding to one or more characteristics of an environment of the vehicle, and wherein the controller is further configured to control the steering system, the braking system, and the throttle system based on the sensor data.

20. The system of claim 19, wherein the controller is further configured to monitor the sensor data and the user input and correlate the sensor data with the user input to improve an obstacle detection ability of the sensing system.
